(19) United States
(12) Patent Application Publication
(10) Pub. No.: US 2021/0101818 A1
(43) Pub. Date: Apr. 8, 2021

(54) ADDITIVE MANUFACTURING SYSTEMS AND METHOD FOR MAKING GLASS ARTICLES

(71) Applicant: CORNING INCORPORATED, CORNING, NY (US)

(72) Inventors: Christopher William Drewnowski, Corning, NY (US); Traci Nanette Harding, Troy, PA (US); Christina Marie Laskowski, Painted Post, NY (US); Joseph Michael Matusick, Corning, NY (US); Kenneth Spencer Morgan, Painted Post, NY (US); James Paul Peris, Horseheads, NY (US); Irene Mona Peterson, Elmira Heights, NY (US); Thomas Matthew Sonner, Coming, NY (US)

(21) Appl. No.: 16/464,563

(22) PCT Filed: Nov. 27, 2017
(86) PCT No.: PCT/US2017/063287

§ 371 Date: May 28, 2019

Related U.S. Application Data
(60) Provisional application No. 62/426,895, filed on Nov. 28, 2016.

(51) Int. Cl. C03B 19/02; C03B 5/02; C03B 25/00

(52) U.S. Cl. CPC C03B 19/025; B33Y 10/00; C03B 25/00; C03B 5/021

(57) ABSTRACT

A glass article manufacturing system (10) includes a crucible (38) that defines a barrel (46) and a nozzle (54). The barrel (46) accepts a glass feedstock (62). A heater 66 is in thermal communication with the nozzle (54). The heater 66 heats the feedstock (62) within the nozzle (54). An actuator (22) is positioned proximate the barrel (46) and extrudes the feedstock (62) through the nozzle (54) as extruded feedstock.

This application claims the benefit of priority under 35 U.S.C. § 119 of U.S. Provisional Application Ser. No. 62/426,895, filed on Nov. 28, 2016, the contents of which are relied upon and incorporated herein by reference in their entirety

### FIELD OF THE DISCLOSURE

The present disclosure generally relates to additive manufacturing systems, and more specifically, to an additive manufacturing system for forming glass articles.

### BACKGROUND

Commonly available additive manufacturing techniques such as stereolithography of a resin filled with glass particles, or direct laser sintering of glass particles may have difficulty creating a part with excellent optical transparency because the glass particles may be difficult to sinter to full density. One additive manufacturing technique used for plastics, known as fused deposition modeling (FDM), has the advantage of using fiber as the feedstock, rather than a powder. In the FDM systems, fibers are pulled into a heated zone using a tractor wheel. Use of FDM with brittle glass fibers in place of the flexible plastic fibers results in broken fibers. In addition, it is not always possible to pull a fiber of the desired glass composition as the viscosity curve of flexible glass fibers is not always compatible with the fiber draw process. Conventional extrusion techniques may also be equally unsuited for additive manufacturing of glass products as extrusion is designed for larger diameters, and may require too high a temperature and pressure to produce a glass bead diameter of a desired size. Another method to lay down a thin bead of glass is to melt glass in a crucible with a hole at the bottom. However, as the diameter of the glass stream decreases, the stability of the stream decreases as well, and the flow stream may spiral and buckle.

### SUMMARY OF THE DISCLOSURE

According to at least one aspect of the present disclosure, a glass article manufacturing system includes a crucible that defines a barrel and a nozzle. The barrel accepts a glass feedstock. A heater is in thermal communication with the nozzle. The heater heats the feedstock within the nozzle. An actuator is positioned proximate the barrel and extrudes the feedstock through the nozzle as extruded feedstock.

According to another aspect of the present disclosure, a glass article manufacturing system includes a crucible that defines a nozzle and accepts a glass feedstock. A platform is positioned proximate the nozzle. An actuator is positioned proximate the crucible and is arranged to apply pressure to the feedstock such that the feedstock extrudes through the nozzle onto the platform as an extruded glass feedstock. The extruded glass feedstock is in the form of a glass article.

According to another aspect of the present disclosure, a method of operating a glass article manufacturing system includes the steps: heating a glass feedstock within a crucible that defines a nozzle; extruding the glass feedstock through an aperture of the nozzle as a bead onto a platform; and moving the platform as the glass feedstock is extruded to form a glass article.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1A is a schematic diagram illustrating an additive manufacturing system at a start time, according to one embodiment;

FIG. 1B is a schematic diagram illustrating an additive manufacturing system at an end time, according to one embodiment;

FIG. 2 is a schematic cross section of a crucible of the additive manufacturing system of FIG. 1A, according to one embodiment;

FIG. 3 is a schematic diagram illustrating an additive manufacturing system, according to another embodiment;

FIG. 4 is a flow diagram of a method for operating the additive manufacturing system, according to one embodiment;

FIG. 5A is top perspective view of a glass article formed using the additive manufacturing system, according to one embodiment;

FIG. 5B is top perspective view of a glass article formed using the additive manufacturing system, according to one embodiment;

FIG. 5C is a perspective view of a glass article formed using the additive manufacturing system, according to another embodiment; and

FIG. 6 is a photograph of an exemplary glass article formed by an additive manufacturing system, according to one embodiment.

### DETAILED DESCRIPTION

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

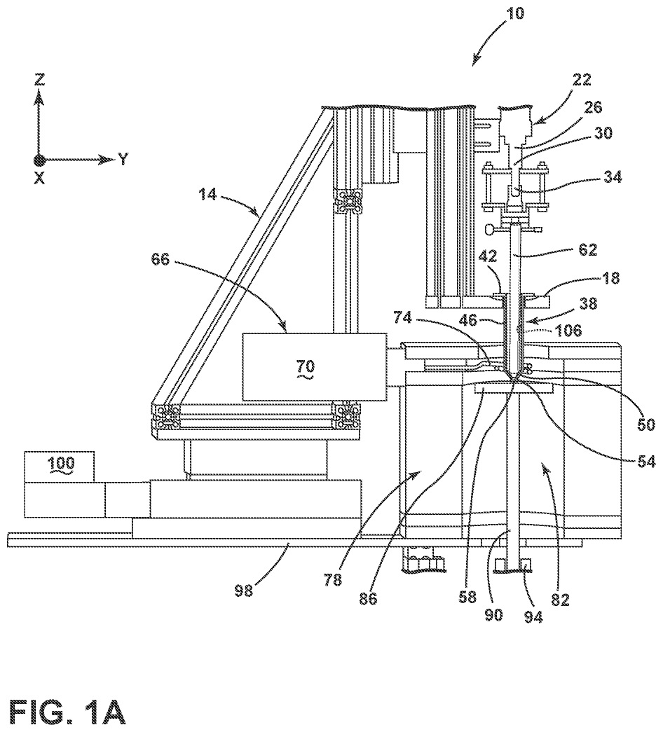

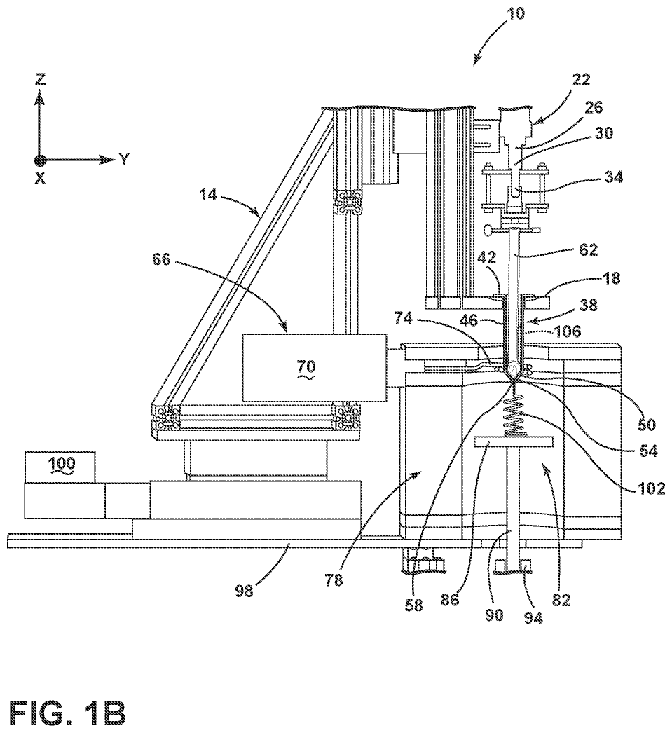

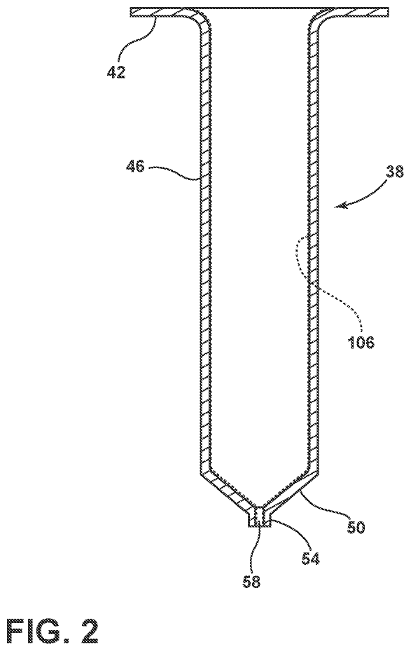

Referring to FIGS. 1A-3, depicted is an additive manufacturing system 10 for making glass articles, among other components. The system 10 includes a support structure 14 including an adapter 18. In the depicted embodiment, an actuator 22 is positioned towards a top of the support structure 14. The actuator 22 includes a servo 26, a load cell 30 and a plunger 34. Positioned below the actuator 22 is a crucible 38. The crucible 38 includes a flange 42, a barrel 46, a knuckle 50, a nozzle 54 and an aperture 58.

In the embodiment depicted in FIGS. 1A-3, the crucible 38 may be held to the support structure 14 by the adapter 18. Positioned within the crucible 38 is a feedstock 62. The system 10 further includes a heater 66. The heater 66 includes an induction unit 70 and an induction coil 74. A furnace 78 is positioned approximate the support structure 14. The furnace 78 defines a cavity 82 into which the crucible 38 extends.

A platform 86 is positioned inside the cavity 82 of the furnace 78. The platform 86 is supported by a support rod 90. The support rod 90 is operably coupled to a Z-stage 94. The Z-stage 94 is configured to move the platform 86 within the cavity 82 of the furnace 78 in a Z-direction. The support structure 14 is coupled to an XY-stage 98. The Z-stage 94 and the XY-stage 98 are configured to move the platform 86 and the crucible 38 with respect to each other. It will be understood that the platform 86 and the furnace 78 may be arranged in a variety of configurations which allow movement relative to one another without departing from the teachings provided herein. For example, the platform 86 and/or furnace 78 may move circularly, cylindrically or in similar movements as defined by Cartesian or polar coordinates.

As will be explained in greater detail below, the additive manufacturing system 10 includes a controller 100 which is configured to regulate a pressure applied by the actuator 22, the heat provided by the heater 66 to the crucible 38 (i.e., and the feedstock 62), the movement of the platform 86 and the crucible 38 relative to each other, and the temperature of the furnace 78 to form a glass article 102.

The support structure 14 is configured to hold various components of the system 10 in place during operation. The support structure 14 may include a linear slide to which the actuator 22 and/or the adapter 18 are coupled such that a crucible 38 and/or the actuator 22 may be adjusted in the Z-direction. The adapter 18 may include a groove to permit seating of the flange 42 of the crucible 38 to the adapter 18. Insulators may be included on both sides of the flange 42 within the adapter 18 while ensuring proper seating of the crucible 38 within the support structure 14. In some embodiments, these insulators may be washers or fiber blankets composed of a ceramic or polymeric material in order to provide electrical isolation to the crucible 38. Further, the insulators may provide thermal insulation between the support structure 14 and the crucible 38.

Positioned above the crucible 38 is the actuator 22. It will be understood that the positional relationship between the actuator 22 and the crucible 38 may be changed depending on the glass article 102 intended to be made. For example, the crucible 38 and the actuator 22 may be positioned substantially at the same height such that the feedstock 62 is actuated in a substantially horizontal direction. The actuator 22 is configured to extend the plunger 34 in order to push the feedstock 62 toward the nozzle 54. For example, the plunger 34 may be coupled in a gripping manner to the feedstock 62 to exert a downward force. In another example, the plunger 34 may press on a face of the feedstock 62 to force the feedstock 62 into the barrel 46 of the crucible 38.

According to a specific embodiment, the servo 26 exerts a force on the plunger 34 which is then extended into the barrel 46. The plunger 34 may have an outside diameter approximately equal to that of an inside diameter of the barrel 46. In such examples, the plunger 34 may “wipe” an inner surface 106 of the barrel 46 such that all of the feedstock 62 is forced toward the nozzle 54. In yet another example, the actuator 22 may include a roller for applying downward force to the feedstock 62. The load cell 30 may measure the amount of force applied by the plunger 34. The actuator 22 may provide from about 0.1 pounds (0.44 N) to about 300 pounds (1334 N) or more of force to the feedstock 62 within the crucible 38. It will be understood that up to 1000 pounds (4448 N) of force may also be applied by the actuator 22 to the feedstock 62. Further, the force applied to the feedstock 62 may be varied over time or though the formation of the glass article 102.

According to various examples, the feedstock 62 may include one or more glasses and glass materials. The feedstock 62 may be formed as a rod having a diameter greater than or equal to about 1 mm, 20 mm, 30 mm, 40 mm, 50 mm, 100 mm, or larger than about 125 mm in diameter. A rod may be distinguished from a filament with respect to the thickness and the compressive force it may withstand as a rod is thicker than a filament and may withstand a greater compressive force. For example, while a filament may be flexible at room temperature, the rod example of the feedstock 62 may not be flexible at room temperature such that the force applied from the actuator 22 does not result in buckling or deformation of the feedstock 62. It will be understood that the diameter of the rod of the feedstock 62 may be adjusted based on the desired size of the glass article 102 to be made. Further, the diameter of the feedstock 62 may be different over the length of the feedstock 62. In other examples, the feedstock 62 may be composed of a plurality of rods (e.g., a bundle), a powder, a plurality of filaments, a plurality of disks (e.g., wafers or patties of the rods), a plurality of particles, a plurality of beads and/or combinations thereof.

As explained above, the feedstock 62 may be formed of a glass or glass material. The glass or glass material of the feedstock 62 may include Pyrex®, quartz, aluminum silicate glasses, soda-lime glass, an aluminosilicate glass, an alkali-aluminosilicate glass, a borosilicate glass, an alkali-borosilicate glass, an aluminoborosilicate glass, an alkali-aluminoborosilicate glass, a fused silica glass, glasses resistant to high thermal shock, glasses with high working ranges, colored glasses, doped glasses, transparent glasses, translucent glasses, opaque glasses and combinations thereof. It will be understood that the composition of the feedstock 62 may change or vary over the length of the feedstock 62. For example, multiple different rods of different compositions of glass may be loaded into the crucible 38 such that at different points during extrusion of the feedstock 62 onto the platform 86, different compositions of glass are formed. Such an embodiment may be advantageous in forming a glass article 102 having different regions of different composition.

According to various embodiments, the glass of the feedstock 62 may have a long working range. The working range of the glass is defined as the range of temperatures that correspond to the point where the glass begins to soften to the point where the glass is too soft to control. In other words, the working range is the range of temperatures at which the viscosity of the feedstock 62 is sufficiently low enough to extrude, but not low enough as too melt and drip out of the nozzle 54. Selection of the glass composition for the feedstock 62 is guided by choosing a glass with a viscosity curve, or working range, which does not result in a burdensome amount of temperature change to affect viscosity. Further, care should be taken during the selection of the glass composition to select a glass with a viscosity curve not so sensitive to temperature change that wide changes in viscosity occur over a short temperature range (e.g., less than 100° C., less than 50° C., less than 10° C.). In other words, when selecting a glass composition for the feedstock 62, the composition should not be difficult to heat to a flowing state, but should also not be difficult to maintain in either a flowing state or a solid state. Glass compositions which include nodes in the viscosity change (i.e., drastic viscosity changes over a small temperature range) may be advantageous for various start and stop and sequences of the system 10. The working range of the feedstock 62 may be greater than or equal to about 100° C., 150° C., 200° C., 275° C., 300° C., 350° C. or greater than about 500° C.

The crucible 38 holds the feedstock 62. As explained above, the crucible 38 includes the flange 42, the barrel 46, the nozzle 54, and defines the aperture 58. The barrel 46 may have an inside diameter greater than or equal to about 10 mm, 20 mm, 30 mm, 34 mm, 40 mm, 50 mm, 100 mm, 200 mm or 500 mm. The barrel 46 may have a thickness of greater than or equal to about 1 mm, 2 mm, 5 mm, 10 mm, 25 mm or 50 mm. It will be understood that the thickness of the barrel 46 may be any practicable thickness for supporting the feedstock 62 under pressure from the actuator 22 and at temperature from the heater 66. The aperture 58 may be positioned at the bottom of the crucible 38 such that the feedstock 62, when heated (e.g., melted or otherwise heated to its working temperature), may be extruded therefrom. The aperture 58 may have an inside diameter of less than or equal to about 500 mm, 125 mm, 25 mm, 3 mm, 1.5 mm, 0.5 mm, or less than about 0.1 mm. It will be understood that the diameter of the aperture 58 may be altered depending on the size of the glass article 102 (e.g., larger aperture 58 for a larger glass article 102 to decrease manufacturing time) or based on a desired bead size of the feedstock 62 extruded through the aperture 58.

The ratio between the inside diameter of the barrel 46 (e.g., an entrance to the nozzle 54) and the aperture 58 may be greater than or equal to about 1, 1.5, 5, 10, 20 or 50. The nozzle 54 may define the aperture 58 as a variety of shapes including circular, square, triangular, star patterned, or other desired shapes of the bead of extruded feedstock 62. Further, the nozzle 54 may be dynamic such that the size and/or shape of the aperture 58 may change throughout a process run of the system 10. For example, the aperture 58 may begin at substantially circular, but may be changed to square or triangular part way through the process run and then optionally returned back to a circular shape. Further, the nozzle 54 may include a mandrel configured to extrude the feedstock 62 as a tube or other hollow structure. A plurality of thermocouples may be attached or otherwise coupled to the crucible 38 through the nozzle 54, the knuckle 50 and the barrel 46 to measure the temperature of the feedstock 62 passing through the crucible 38 and different points.

The crucible 38 may be formed of a conductive metal such as platinum, rhodium, steel, stainless steel, and other metals with a melting temperature sufficiently above the working range of the feedstock 62. In a specific example, the crucible 38 may be formed of an 80 weight percent (wt. %) platinum and 20 wt. % rhodium alloy. The crucible 38 may be formed of metal with a melting point greater than a softening point of the feedstock 62. Metals of the crucible 38 may also be selected based on the reactivity of the metal with the glass. For example, metals which are not reactive with the feedstock 62 may be used. Reactivity between the feedstock 62 and the material of the crucible 38 may include the transfer of ions or elements between the feedstock 62 and the material of the crucible 38 to a point at which either the feedstock 62 and/or crucible 38 is unsuitable for its intended purpose (e.g., a property or characteristic changes).

Additionally or alternatively, the crucible 38 may include one or more inserts positioned between the barrel 46 and the feedstock 62. The inserts may be formed of a different material than the crucible 38. The inserts may take the form of a separate component inserted into the crucible 38 and/or take the form of a film or coating deposition on interior surfaces of the crucible 38. Use of such inserts may be advantageous in broadening the materials that may be used for the crucible 38 (e.g., metals which otherwise be reactive with the feedstock 62) by separating contact between the feedstock 62 and the material of the crucible 38. For example, the crucible 38 can be made of stainless steel and the insert or film positioned on the inside of the crucible 38 may be a platinum rhodium alloy with low reactivity to the feedstock 62. The metal selected for the crucible 38 may also be selected based on a creep resistance property. As the temperature of the crucible 38 increases, the force on the crucible 38 from the actuator 22 may result in a strain of the crucible 38. Accordingly, materials having a high creep resistance, or low susceptibility to strain when under force at high temperatures, may be utilized for the crucible 38.

According to various embodiments, at the beginning of a process run of the system 10, the first rod of feedstock 62 inserted into the crucible 38 may be machined such that an exterior surface of the feedstock 62 substantially matches an interior surface of the nozzle 54 of the crucible 38 such that heat may be more efficiently transferred from the crucible 38 to the feedstock 62. Such a machining of the feedstock 62 may lessen the amount of time necessary to begin producing the glass article 102.

As explained above, the additive manufacturing system 10 includes the heater 66. The heater 66 includes the induction unit 70 and the induction coil 74. The induction unit 70 is configured to provide alternating current to the induction coil 74 such that the induction coil 74 may inductively heat the crucible 38. In other words, the heater 66 is in thermal communication with nozzle 54 of the crucible 38. The heat of the crucible 38 is then transferred to the feedstock 62 to heat the feedstock 62. The amount of power provided by the induction unit 70 may be altered during a process run of the additive manufacturing 10 based on desired characteristics of the feedstock 62 as it is extruded into the glass article 102. The induction coil 74 is depicted as surrounding the knuckle 50 of the crucible 38, but it will be understood that the induction coil 74 may be positioned in a number of locations along the length of the crucible 38. Further, multiple induction coils 74 may be utilized along the crucible 38 in order to heat various locations of the feedstock 62. Use of the induction coil 74 may be advantageous in providing nearly instantaneous control of the temperature of the crucible 38 and the feedstock 62. It will be understood that the induction unit 70 and the induction coil 74 of the heater 66 may be replaced by other forms of heating the crucible 38. For example, the heater 66 may be used in conjunction with, or replaced by, a flame heat system, an infrared heating system, a resistance coil heating system (e.g., a nichrome wrap) and other forms of heating.

In the depicted embodiment, the furnace 78 is positioned below the crucible 38. The crucible 38 extends into the cavity 82 of the furnace 78. It will be understood that the crucible 38 may extend into the furnace 78 or the aperture 58 may be coplanar with an entrance of the furnace 78. The furnace 78 may be sealed at a top and a bottom to keep a heated environment within the furnace 78. The cavity 82 of the furnace 78 may be filled with an inert gas (e.g., non-reactive to the glass article 102 over the feedstock 62) or may be filled with typical atmospheric gases. The furnace 78 may keep a temperature sufficiently high to anneal the glass article 102 but lower than the working temperature of the feedstock 62. The temperature of the furnace 78 may be sufficiently high to keep the extruded glass article 102 pliable, but not high enough to allow sag in the article 102.

The platform 86 is positioned within the cavity 82 of the furnace 78. It will be understood that the platform 86 may be replaced with any build surface or substrate. As explained above, the platform 86 is positioned within the furnace 78 to accept or receive the extruded glass feedstock 62. It will be understood that a component (e.g., a mechanical and/or electrical part) may be placed on the platform 86 and received the feedstock 62 such that the glass article 102 is a subcomponent of a larger component. The support rod 90 extends from a bottom of the platform 86, through the cavity 82 and out of the furnace 78. The support rod 90 is coupled with the Z-stage 94 such that the platform 86 may be raised and lowered in the Z-direction. Further, the support structure 14 is coupled with the XY-stage 98 such that the nozzle 54 and the platform 86 may be moved in the X-, Y- and Z-directions relative to each other. According to at least one alternative example, the support structure 14 may be coupled to the Z-stage 94 and the XY-stage 98 such that the controller 100 may regulate movement of the crucible 38 relative to the platform 86. Such an example may be advantageous for the production of large glass articles 102 (i.e., such that the large glass article 102 does not have to be moved). In another alternative example, the platform 86 may be coupled to the Z-stage 94 and the XY-stage 98 such that the controller 100 may regulate movement of the platform 86 relative to the crucible 38. Such an example may be advantageous for the production of smaller glass articles 102 (i.e., because the relatively larger support structure 104 may remain stationary). Even further, all or some of the system 10 may be positioned within the furnace 78 for the production of large glass articles 102.

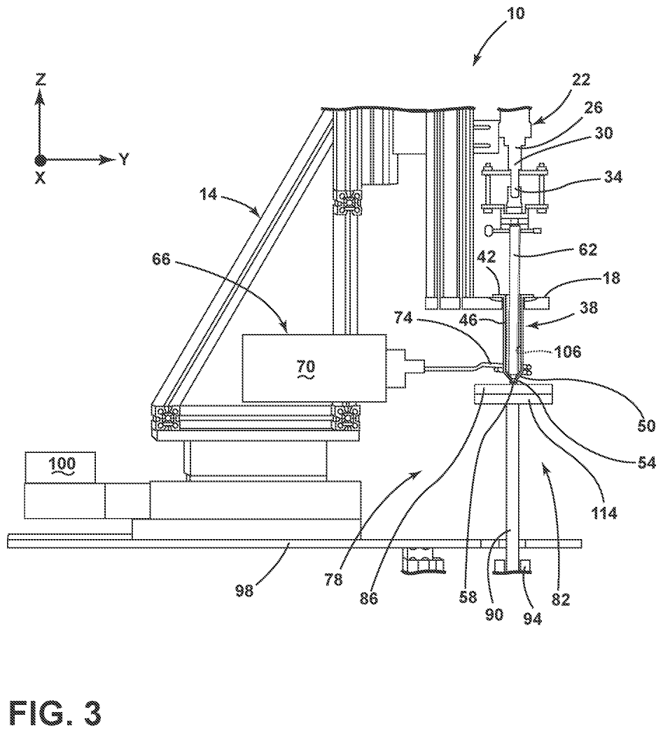

According to some embodiments, a heating element 114 (FIG. 3) may be positioned on a bottom of the platform 86. The heating element 114 may extend over all or a portion of the platform 86. The heating element 114 may be configured to heat all of or just a portion of the platform 86 (i.e., to form hot and cold zones on the platform 86). As such, the platform 86 may form a heated build surface. Such hot and cold zones may be advantageous in manufacturing the glass article 102 to have different properties throughout its structure. Heating of the platform 86 by the heating element 114 may decrease a thermal shock experience by the glass article 102 as the feedstock 62 is extruded from the crucible 38. Use of the heating element 114 may be advantageous in embodiments of the additive manufacturing system 10 not incorporating the furnace 78 (e.g., FIG. 3) or an embodiments where the furnace 78 is kept at a lower temperature. It will be understood that in commercial examples of the system 10, the platform 86 may be a portion of a conveyor belt or other assembly line component configured to mass produce the glass articles 102. In such an example, the crucible 38 may be configured to move relative to the platform 86.

In operation of the system 10, the controller 100 is configured to instruct the actuator 22 to exert a force on the feedstock 62 to move the feedstock 62 into the crucible 38. As the crucible 38 is heated, the heat is transferred to the feedstock 62. The feedstock 62 is heated to a temperature within its working range such that the feedstock may begin to flow through the aperture 58 of the nozzle 54 under the pressure from the actuator 22. As such, the feedstock 62 is extruded through the nozzle 54 of the crucible 38. The feedstock 62 may be heated proximate the knuckle 50 and the nozzle 54, but also at points throughout the barrel 46. The feedstock 62 exits the nozzle 54 as a continuous bead of material. The feedstock 62 then contacts the platform 86 and begins to “set up,” or cool as it is extruded. In other words, as the feedstock 62 contacts the platform 86, the feedstock 62 cools and increases in viscosity until the feedstock 62 solidifies.

After the bead of feedstock 62 contacts the platform 86, the platform 86 may begin to move in a 3-dimensional manner using the Z-stage 94 and/or the XY-stage 98. As explained above, additionally or alternatively, the crucible 38 may be moved relative to the platform 86 (e.g., for the production of large glass articles 102). As the platform 86 is moved relative to the nozzle 54, the bead of feedstock 62 begins to extend through space (i.e., and solidify as it goes) to form the glass article 102. In other words, the feedstock 62 solidifies as it is extruded such that the glass article 102 maintains the shape generated by the relative motion of the platform 86 and the nozzle 54. At an end point of the glass article 102, the controller 100 controls the heater 66 to stop heating of the crucible 38 which in turn returns the feedstock 62 to a temperature lower than its working range. The relatively quick reduction of the temperature of the feedstock 62 and crucible 38, in addition to a removal of the force applied by the actuator 22, causes the feedstock 62 to suck back into the nozzle 54 due to a negative pressure. Further, the actuator 22 may pull back on the feedstock 62 resulting in the feedstock 62 being sucked back into the nozzle 54. Such a quick temperature shift and recoiling of the feedstock 62 back into the nozzle 54 may help starting and stopping the material flow, and reducing or eliminating “hairs,” or fine strands of material extending away from the glass article 102 toward the nozzle 54, at the article's end point. Further, a rapid motion by the nozzle 54 at the end of the run (relative to the formed glass article's end point), in addition to the change in temperature and pressure, may remove hairs from an end point of the glass article 102. The controller 100 may control the actuator 22 and platform 86 in concert to create the glass article 102 from a single continuous bead of feedstock 62, from a plurality of beads of feedstock 62 laid on one another, or combinations thereof. At hotter temperatures of extrusion and/or of the furnace 78, the beads of feedstock 62 may merge into a seamless, optically transparent, multilayer structure.

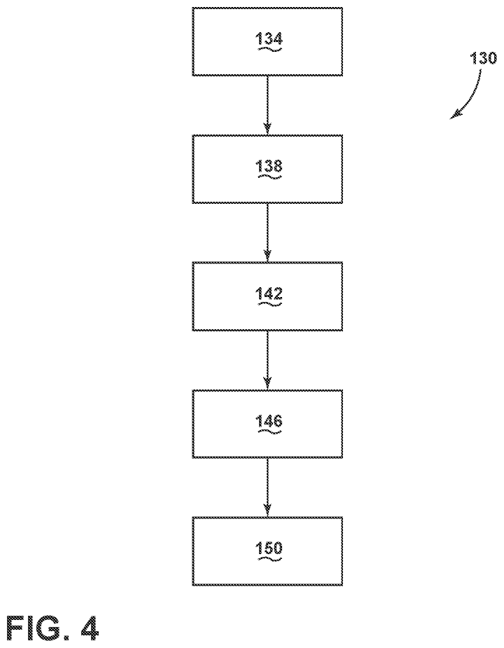

Referring now to FIG. 4, depicted is an exemplary method 130 of operating the additive manufacturing system 10 to produce the glass article 102 (FIG. 1A). The method 130 begins with step 134 of inserting the feedstock 62 into the crucible 38 if the system 10. The feedstock 62 may be coupled to the actuator 22 at the same time. Next, step 138 of heating the glass feedstock 62 within the crucible 38 is performed. As explained above, the heater 66 heats the crucible 38 which in turn heats the glass feedstock 62 within the crucible 38. The heater 66 heats the feedstock 62 to a sufficiently high temperature such that the feedstock 62 is within its working range.

Next, step 142 of extruding the glass feedstock 62 through the nozzle 54 onto the platform 86 is performed. In step 142, the actuator 22 applies sufficient force to the feedstock 62 such that the portion of the feedstock 62 heated to its working range is extruded through the nozzle 54 and onto the platform 86. The feedstock 62 is extruded as a bead. The controller 100 may control the actuator 22 to extrude a single, continuous, bead or a plurality of smaller beads of feedstock.

Next, step 146 of moving at least one of the crucible 38 and the platform 86 is performed. As explained above, the controller 100 is configured to regulate positional control of the crucible 38 and/or the platform 86 relative to one another. The controller 100 is configured to move the crucible 38 and/or the platform 86 as the feedstock is extruded from the nozzle 54 to form the glass article 102. The controller 100 controls the position of the crucible 38 and/or platform 86 such that the bead(s) of feedstock 62 is placed on the platform to build the glass article 102. While moving the crucible 38 and/or the platform 86, the controller 100 may be configured to drag the nozzle 54 through the previously applied bead of feedstock 62. The nozzle 54 may be dragged through the bead at a depth less than or equal to about half the thickness of the material layer being deposited. Dragging the nozzle 54 through the bead of feedstock 62 on the platform 86 may be advantageous in helping to smear the previously laid bead of feedstock 62 and create better adhesion between beads of feedstock 62 laid on top of one another. Better adhesion between the beads may result in tighter stack-up tolerances.

Next, step 150 of annealing the glass article 102 may be performed. Annealing of the glass article 102 may be performed in the furnace 78 and the temperature and time at which the glass article 102 is annealed may be regulated by the controller 100.

It will be understood that the steps of the method 130 may be performed in any order, repeated, omitted and/or performed simultaneously without departing from the teachings provided herein.

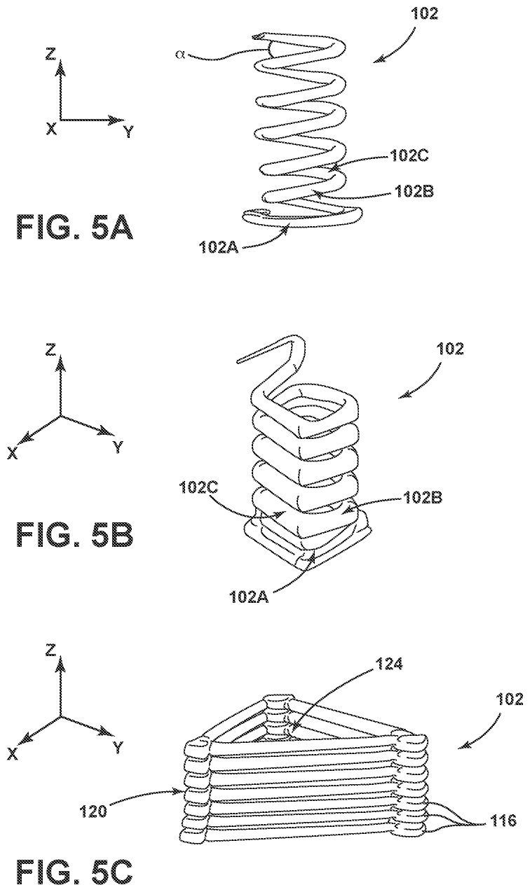

Referring now to FIGS. 5A-5C, depicted are various embodiments of the glass article 102 as manufactured by the system 10. According to various examples, the glass article 102 may be substantially transparent and/or colorless. The glass article 102 may have a transparency greater than about 60%, 70%, 80%, 90% or greater than about 99% for visible light. The glass article 102 is composed of one or more beads extruded proximate one another to form the glass article 102. For example, the glass article 102 may include a single bead (FIGS. 5A and 5B) extending through a three dimensional space or a single or multiple beads stacked on one another (e.g., FIG. 5C).

In single bead examples, the glass article 102 may define a base portion 102A, a first body portion 102B and a second body portion 102C. The first and second body portions 102B, 102C may be coupled such that a self-supporting angle α between the first and second body portions 102B, 102C is less than or equal to about 45°. The glass articles 102 may have a self-supporting angle α of less than about 45°, 30°, 20°, 10° or less than about 1° as measured in an XZ and/or YZ plane relative to a horizontal XY plane. It will be understood that the self-supporting angle α may be formed at any angle between about 0.1° and about 180°. For purposes of this disclosure, the self-supporting angle α is the angle at which the glass article 102 may support an extension without an additional support structure (e.g., a tower or additional mold piece configured to hold up the extension of the glass article 102). In other words, the self-supporting angle α has no supporting structure that extends between the first and second body portions 102B, 102C. Conventional additive manufacturing systems often utilize one or more fugitive materials to form a support structure. The fugitive material may be etched, melted and/or burned away after formation of the article to form the self-supporting angle α. The presently disclosed system 10 may be capable of forming the self-supporting angle α in the glass article 102 without the use of fugitive materials and/or a support structure. It is believed that such self-supporting angles α are feasible because the glass feedstock 62 sets up as it is extruded onto the platform 86. In other words, it is believed that the feedstock 62 sufficiently solidifies as it is extruded to provide enough strength to form the self-supporting angle α. Such self-supporting angles α allow considerable over-hang as compared to articles formed using conventional additive manufacturing systems. Further, the glass article 102 may exhibit bends, or changes of direction, of less than about 135°, 90°, 45°, 10° or less than about 1°. It will be understood that a bend or change in direction of the glass article 102 may be between about 0.1° and about 359°.

In alternative examples, the glass article 102 may be formed of a plurality of glass beads arranged in a stack to form the three-dimensional glass article 102. In such an example, each bead may be fused to an adjacent bead. It will be understood that although described as a plurality of beads, the glass article 102 may be formed from a single continuous bead folded or guided back onto its self. The beads may be fused to one another over the length of the beads or at a plurality of points. In such examples, the glass article 102 may be substantially transparent through the stack of fused beads. As explained above, the beads of extruded feedstock 62 may flow into crevices formed between adjacent beads which may enhance the transparency of the glass article 102 (e.g., due to elimination of air voids between the beads). Further, the glass article 102 may define one or more voids within the article 102 formed through placement of the beads of feedstock 62. As explained above, by positioning, or dragging, the nozzle 54 in a previously laid bead of the feedstock 62, the stack-up tolerance of the glass article 102 may be minimized with respect to conventional glass additive manufacturing techniques. The glass article 102 may take a variety of configurations. For example, the glass article 102 may form a glass encapsulation device (e.g., for electronic devices), a flow reactor, or a nose cone with conformal cooling channels. The glass article 102 may be substantially or completely bubble free and may be of a complex design. As explained above, the composition of the glass article 102 may vary across the stack (i.e., in multiple bead or stacked single bead examples) and/or across individual beads.

A variety of advantages may be obtained using the disclosure provided herein. First, the additive manufacturing system 10 may produce a glass article 102 which is substantially transparent, bubble free and of a complex design. Second, the glass article 102 may have an increased overhang with the respect to conventional additive manufacturing techniques due to the decrease in self-supporting angle α provided by the system 10. Third, use of the furnace 78 may prevent a thermally induced curl in the glass article 102 and may prevent the glass article 102 from undergoing a thermal shock. Fourth, complex designs, including tubes, may be formed in the glass article 102. Fifth, the improved starts/stop control of the system 10 results in increased consistency at an end point of the glass article 102 (e.g., a decrease in the production of “hairs”). A decrease in the presence of hairs may allow for a more aesthetically pleasing and complex article 102 to be formed. Sixth, the system 10 may extrude a bead of the feedstock 62 onto an existing component to form a glass portion of that component. Seventh, the composition and/or properties (e.g., color, transparency, resistance to thermal shock, etc.) of the feedstock 62 may be altered through the process run that different portions of the glass article 102 exhibit different properties. Eighth, as the feedstock 62 is extruded and solidifies, molds and other conventional forming techniques for glass components may not be necessary which may save manufacturing time and cost. Ninth, the system 10 is scalable to produce glass articles 102 of nearly any size by changing the size of the crucible 38, nozzle 54 and/or actuator 22. Tenth, use of the rod examples of the feedstock 62 instead of traditional filaments allows longer operating times between when the system 10 must be reloaded with more feedstock 62.

### Example

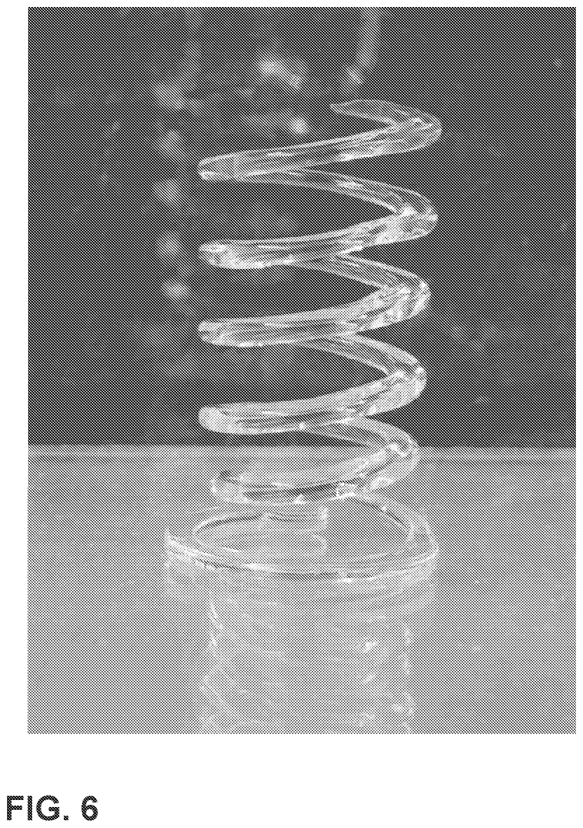

Depicted in FIG. 6 is a photograph of a glass structure (e.g., the glass article 102) produced using a three dimensional glass printer (e.g., the system 10). As can be seen, the glass structure is substantially transparent and exhibits a substantial overhang due to the structure's low self-supporting angle (e.g., less than about 45°). The structure is formed from a single, continuous, bead of glass through three dimensional space. The bead exhibits a smooth upward curve to provide a general “cork screw” form to the glass structure. A feed material (e.g., feedstock 62) used by the printer was Pyrex® glass.

Modifications of the disclosure will occur to those skilled in the art and to those who make or use the disclosure. For example, the plunger 34 of the actuator 22 may be replaced by rollers configured to exert a downward force on the feedstock 62. In another example, the system 10 may be used to form glass articles 102 having a simple, substantially two dimensional, shape. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

1. A glass article manufacturing system, comprising:
a crucible comprising a barrel and a nozzle, the barrel accepts a glass feedstock;
a heater in thermal communication with the nozzle, the heater heats the feedstock within the nozzle;
a furnace positioned proximate the nozzle that anneals the extruded feedstock; and
an actuator positioned proximate the barrel that extrudes the feedstock through the nozzle as extruded feedstock.

2. The system of claim 1, further comprising:
a build surface that receives the extruded feedstock from the nozzle.

3. The system of claim 2, wherein the build surface comprises a heated surface proximate the nozzle.

4. (canceled)

5. The system of claim 2, further comprising:
a controller that regulates movement of the crucible and the build surface relative to each other.

6. The system of claim 1, wherein the heater comprises an induction coil, a resistance coil or combinations thereof.

7. The system of claim 1, wherein the crucible comprises a metal with a melting point greater than a softening point of the feedstock.

8. The system of claim 1, wherein the actuator comprises a plunger that presses the feedstock.

9. The system of claim 8, wherein the plunger is further arranged to wipe an inside surface of the barrel.

10. The system of claim 1, wherein the glass feedstock is a rod having a diameter greater than about 1 mm.

11. The system of claim 1, wherein a composition of the glass feedstock varies over a length of the feedstock.

12. The system of claim 1, further comprising:
an insert positioned between the barrel and the feedstock.

13. A glass article manufacturing system, comprising:
a crucible comprising a nozzle, the crucible accepts a glass feedstock;
a platform positioned proximate the nozzle; and
an actuator positioned proximate the crucible and arranged to apply pressure to the feedstock such that the feedstock extrudes through the nozzle onto the platform as an extruded glass feedstock, the extruded glass feedstock in the form of a glass article.

14. The system of claim 13, wherein the extruded glass feedstock is substantially transparent and has a working range of greater than or equal to 100° C.

15. The system of claim 13, further comprising:
a controller to regulate a heater in thermal communication with the nozzle.

16. The system of claim 15, wherein the controller regulates a furnace positioned proximate the nozzle to anneal the glass article.

17. The system of claim 15, wherein the heater comprises an induction coil, a resistance coil, or combinations thereof.

18. The system of claim 13, further comprising:
a heating element to heat the platform.

19. The system of claim 15, wherein the controller regulates movement of the platform relative to the crucible.

20. The system of claim 15, wherein the controller regulates movement of the crucible relative to the platform.

21. The system of claim 15, wherein the controller regulates movement of the platform and the nozzle in X-, Y- and Z-directions relative to one another.

22. A method of operating a glass article manufacturing system, comprising the steps:
heating a glass feedstock within a crucible comprising a nozzle;
extruding the glass feedstock through an aperture of the nozzle as a bead onto a platform; and
moving the platform as the glass feedstock is extruded to form a glass article.

23. The method of claim 22, further comprising the step:
annealing the glass article.

24. The method of claim 22, wherein the glass feedstock is a rod.

25. The method of claim 22, further comprising the step of:
dragging the nozzle through the bead.

26. The method of claim 22, wherein the platform is heated.

27. A glass article formed by the system of claim 1, comprising:
a base portion;
a first body portion coupled to the base portion; and
a second body portion coupled to the first base portion, the first and second body portions coupled at a self-supporting angle of less than about 45° relative to an XZ or YZ plane.

28. The glass article of claim 27, wherein the self-supporting angle is less than about 40°.

29. The glass article of claim 27, wherein no supporting structure extends between the first and second body portions.

30. The glass article of claim 27, wherein the glass article is substantially transparent.

31. The glass article of claim 27, wherein the base portion, the first body portion and the second body portion are integrally defined.

32. The glass article of claim 27, wherein a composition of the glass article varies throughout the glass article.

33. A glass article formed by the method of claim 22, comprising:
a plurality of glass beads arranged in a stack to form a three-dimensional object, each bead being fused to an adjacent bead, wherein the article is substantially transparent through the fused beads.

34. The glass article of claim 33, wherein the stack of glass beads defines a bend of less than about 90°.

35. The glass article of claim 33, wherein the stack defines a void within the glass article.

36. The glass article of claim 33, wherein the stack defines a self-supporting angle in a XZ or YZ plane of less than or equal to about 45° between adjacent beads.

37. The glass article of claim 33, wherein a composition of the glass article varies across the stack.

38. The glass article of any of claim 33, wherein a composition of the glass article varies across at least one bead.
